(19) United States
(12) Patent Application Publication
(10) Pub. No.: US 2015/0251711 A1
(43) Pub. Date: Sep. 10, 2015

(54) METHOD AND APPARATUS FOR REDUCING VEHICLE DRAG

(71) Applicant: James Carlson, El Paso, TX (US)

(72) Inventor: James Carlson, El Paso, TX (US)

(21) Appl. No.: 13/623,492

(22) Filed: Sep. 20, 2012

(51) Int. Cl. B62D 35/02; B60R 16/027; B60R 16/023

(52) U.S. Cl. CPC B62D 35/02; B60R 16/0237; B60R 16/027

(57) ABSTRACT

A drag reduction method and apparatus for reducing aerodynamic pressure drag associated with a vehicle in motion by use of substrates that can perform as turbulators. The substrates can have a texture that increase the momentum of the air in the boundary layer about a vehicle, moving separation points, and reducing low pressure areas thereby improving the fuel economy of the vehicle. The substrate can reduce the effects of the pressure drag by creating a turbulent boundary layer over the surface of the vehicle, moving separation points downstream where they produce less drag on the vehicle. An automated turbulator deployment system is also disclosed that provides improved aesthetics and can tailor the aerodynamic profile of a vehicle based on the current aerodynamic conditions.

CROSS-REFERENCE TO PROVISIONAL PATENT APPLICATION

This patent application is a Continuation in Part claiming priority to U.S. patent application Ser. No. 12/570,133 which claims priority under 35 U.S.C. §119(e) to U.S. Provisional Patent Application Ser. No. 61/104,016, entitled “Drag Reducing Tape—Grit Tape,” filed on Oct. 9, 2008 with the U.S. Patent & Trademark Office. U.S. Provisional Patent Application Ser. No. 61/104,016 is herein incorporated by reference in its entirety.

### TECHNICAL FIELD

This invention relates generally to aerodynamic drag reduction in land vehicles and also relates to techniques for reducing aerodynamic drag imposed on vehicles using configurable and removable substrates that can induce turbulence at the vehicle's surface when a vehicle is in motion. Such substrates are referred to as turbulators.

### BACKGROUND OF THE INVENTION

As a vehicle moves through the air, a boundary layer is formed proximate to the surface of the vehicle. The boundary layer can be defined as a perpendicular distance measured from the surface of the vehicle to where the air flows freely (uninterrupted flow of air) above the surface of the vehicle. The momentum of the airflow in the boundary layer typically slows and loses kinetic energy as it traverses the length of a surface. As the boundary layer loses kinetic energy and slows, adverse pressure gradients form within the boundary layer slowing the velocity of the air proximate to the vehicle surface. Accordingly, a point is reached along surfaces of a vehicle where the boundary layer trips the flow of air above the boundary layer and the air in the boundary layer transitions from a laminar flow to a turbulent flow.

Locations where this transition occurs are called separation points. Such a turbulent flow near surfaces of a vehicle causes adverse pressure differentials that create drag on the vehicle which oppose forces that move the vehicle forward. Thus, when flow-fields separate they cause an increased drag on the vehicle, which results in increased fuel consumption and an increased noise level as perceived by the driver.

As stated above, pressure drag is a particular form of drag experienced by a moving vehicle that results from a separation of the laminar (i.e. smooth) airflow over various surfaces of the vehicle. After the laminar airflow separates from a surface, the airflow transitions to turbulent airflow. As stated above, the transition from laminar to turbulent airflow creates lower pressure regions or pockets of low pressure about various surface regions on the vehicle. This is particularly apparent in regions behind a vehicle, as low pressure areas are often created directly behind a vehicle. This particular drag force, which the vehicle has to overcome as it moves forward, is called pressure drag.

Several approaches have been proposed to reduce the aerodynamic drag on a vehicle by increasing the momentum of the airflow proximate to surfaces of the vehicle. Such approaches, however, do not adequately increase the momentum of the boundary layer with passive turbulators formed with various substrates of coarse material. Many current approaches require an input of additional energy or consume energy which is added to the flow of air over the vehicle. When energy is consumed or derived from the vehicle itself, this reduces the overall efficiency of the vehicle and generally such a configuration will not significantly reduce fuel consumption. In the prior art, fans and ducts have been be employed to redirect air flow into the boundary layer to generate the increased momentum in the airflow proximate to the vehicle.

Any perceived solution that adds or consumes energy from the vehicle's source of energy is less than perfect. No efficiency is realized when energy is taken from the vehicle power plant and added to the boundary layer. The additional energy applied to the flow of air over a vehicle may positively or adversely affect the performance of the vehicle, but drawing the additional energy from the vehicle subtracts from the overall efficiency of the vehicle.

One approach that does use passive turbulators in the form of a substrate teaches creating a rough surface to the front third of a hypersonic vehicle's body. However, since land vehicles do not travel at supersonic speeds there can be no nexus between applying such a teaching (covering the front third of a vehicle) to land vehicles because such a teaching would not work when applied to a and vehicle. It can be appreciated that aerodynamics at highway speeds is a different art than aerodynamics at hypersonic speeds.

Dimples or recessed holes found on golf balls are another way in which pressure drag on moving objects can be reduced. When a golf ball is in flight, spin of the ball increases the velocity of airflow over at least a portion of the ball. The dimples add momentum to the air flow in the boundary layer over the ball thereby reducing pressure drag. One invention suggested the use of holes punched into tape and placed onto a car's hood to reduce drag but did not demonstrate their use by making permanent impressions into the sheet metal of a car's surface. Also, such a configuration with tape is less than perfect because holes in tape do not follow the profile of dimples in golf balls and may not provide the desired results.

Another approach to reducing drag on a and vehicle is to use vortex generators, which are different from turbulators. Vortex generators affect the flow of air above the boundary layer whereas turbulators affect the flow of air within the boundary layer. Turning the flow of air above the boundary layer into a vortex affects the flow of air above the boundary line, which may also affect the flow of air in the boundary layer. One such application used tabs connected to a car's surface with tape; these tabs extended above the boundary layer creating a vortex above and below the boundary layer. Although vortex generators such as tabs may reduce pressure drag, it is a different method when compared to turbulators and may affect the vehicle differently as the free flow of air is also disturbed.

Based on the foregoing, it is believed that a need exists for improved arrangements for increasing the efficiency of land vehicles by reducing aerodynamic drag with permanent, removable, and/or configurable turbulators.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiment to provide for an improved drag reduction method and apparatus for land vehicles. With the desire for ever more efficient vehicles, major efforts are underway to make vehicles more aerodynamic by minimizing various types of drag encountered by vehicles. Through experimentation we have determined that at higher speeds, the small increase in drag associated with deployment of substrates that cause turbulence (turbulators) is negligible compared to the benefits caused by turbulators which when properly deployed reducing effects of stagnant air pockets that form at separation points in the boundary layer along a vehicle's surface. The disclosed embodiments consider many aerodynamic factors for a particular vehicle and allow the vehicle to be aerodynamically tuned such that maximum aerodynamic efficiency can be achieved.

It is another aspect of the disclosed embodiment to provide for a way to implement improved turbulator/substrate configurations with improved aesthetics where the substrates will reduce aerodynamic drag on a vehicle by increasing the boundary layer momentum about surfaces on the vehicle.

It is a further aspect of the disclosed embodiment to provide for an improved method for adding, removing, deploying, and configuring substrates on a vehicle's surfaces.

It is yet another aspect of the disclosed embodiments to provide an automated substrate/turbulator deployment system with sensors, a processor, and actuators that provide improved aesthetics by hiding the substrates at low speed when they are least effective and can deploy the substrates at higher speeds when they can be most effective. In addition, the deployment system can adjust the location and configuration of the substrates about the vehicle such that the aerodynamic profile of the vehicle can be tailored to the existing conditions or current aerodynamic profile of the vehicle based on then current conditions.

The aforementioned aspects and other objectives and advantages can be achieved as described herein. A drag reduction method and apparatus for reducing aerodynamic drag associated with a vehicle in motion by increasing momentum of a boundary layer is disclosed. In accordance with the disclosed embodiments adjustable, removable, and configurable strips or substrates of varying shapes having different coarseness textures can be added to, removed, and adjusted at various strategic locations on the exterior surface of a vehicle. As a result, pressure drag can be reduced and efficiency for this type of drag can be improved for a particular vehicle. In some embodiments, substrates shaped as strips can be affixed proximate to leading edges of the vehicle, for example, in front of, or on the leading edge of the hood, just behind the windshield, etc., to reduce vehicle drag.

When applied correctly, the substrates disclosed increase the momentum of air in the boundary layer about a vehicle without drawing or using energy from the vehicle's power source. The disclosed embodiments allow for unharnessed energy to be drawn from the free stream flow of air flow inherently present while the vehicle is in motion. As the airstream flows over the substrate, the texture of the substrate creates turbulence in the boundary layer of air proximate to the surface of the vehicle. The turbulent flow in the boundary layer increases the overall momentum of air in the boundary layer, which moves the separation point further aft on the vehicle. Such an approach reduces the overall drag on a vehicle and lowers the amount of energy required to propel the vehicle at highway speeds, thereby improving fuel economy.

### BRIEF DESCRIPTION OF THE DRAWINGS

The accompanying figures, in which like reference numerals refer to identical or functionally-similar elements throughout the separate views and which are incorporated in, and form a part of the specification, further illustrate the present invention and, together with the detailed description of the invention, serve to explain the principles of the present disclosure.

FIG. 1 is a top view of a vehicle illustrating substrates at various locations on the vehicle;

FIG. 2 is a side view of a vehicle illustrating substrates at various locations on the vehicle;

FIG. 3 is a side view of a front of a vehicle having a substrate deployment system; and

FIG. 4 is flowchart showing one method for deploying substrates.

### DETAILED DESCRIPTION

As part of the invention, the particular data and configurations discussed in the non-limiting examples below are not intended to and should not limit the scope of the inventions as they are provided merely to illustrate at least one embodiment of a broad collection of embodiments and are not intended to limit the scope of the present invention.

One method for reducing drag on a and vehicle is to use vortex generators (tabs); however, such a configuration provides different results than the use of substrates to create turbulence in the boundary layer. Vortex generators affect the flow of air above the boundary layer; where substrates affect the flow of air within the boundary layer. Turning the flow of air above the boundary layer into a vortex affects the flow of air above and below the boundary line. Although this may reduce pressure drag in part, it is an inefficient method when compared to substrates.

Turbulators by their nature are not smooth and for some individuals they might be unsightly and detract from the curb appeal of a shiny new automobile. Also based on their shape, each vehicle has a different aerodynamic profile and thus each vehicle will have different areas that produce pressure drag when in an airstream. Thus, it would be desirable to be able to customize the placement of drag reducing features on different parts of an automobile.

The disclosed embodiments may be employed to reduce drag associated with a vehicle traveling above 20 mph and have been proven to improve the fuel economy of a vehicle. The disclosed passive drag reduction system described herein provides efficient and effective drag reduction increasing the momentum of air flowing in the boundary layer of the vehicle. The disclosed drag reduction system can be permanently or temporarily mounted on the surface of any land vehicle such as, for example, cars, sport utility vehicles, trucks, trailers, buses, recreational vehicles, enclosed trailers, recreational trailers, all types of vans, including mini-vans, and the like. The vehicle may be propelled by any sort of engine such as, for example, an internal combustion engine, and can be powered by any energy source such as gasoline, diesel fuel, electricity, natural gas, etc.

When air flows over a rigid body such as the vehicle illustrated, there is a layer of air called the boundary layer between the body's surface and an area where the air has not been disturbed by the movement of the body. Depending on the profile of the body, the air will often flow smoothly in a thin boundary layer across much of the body's surface. The boundary layer will typically have laminar flow proximate to all leading edges of the body and the airflow above the boundary layer will become turbulent a certain distance from the leading edge depending on roughness or smoothness of the surface proximate to the leading edges and the speed of the body.

However, there comes a distance aft of the leading edge, i.e. the separation point, where the smooth laminar flow over the vehicle surface breaks away from the surface due to the pressure gradients on the air stream in the boundary layer. At highway speeds, a significant propulsive force is required to move and vehicles, for example, cars, sport utility vehicles, busses, and trucks in the face of aerodynamic resistance. A significant amount of energy is required to provide the propulsive force required to overcome pressure drag on a vehicle.

Empirical tests on slower moving vehicles show that only the first few inches of a smooth surface need a textured surface to produce desirable results and not the full third of the vehicle's body. Although, tested and useful for aircraft at supersonic speeds, covering the front third of a hypersonic vehicle has little if any applicability to vehicles traveling at highway speeds. Also, the use of a turbulator for supersonic aircraft is not suitable for removable and configurable substrates as they would fly off at higher speeds.

Turbulators have been utilized on various control surfaces on aircraft to tune airflow for various segments of flight and although some aircraft in certain phases of flight travel at speeds similar to those achieved by land vehicles, land vehicle do not utilize control surfaces. Turbulators embodied as substrates can be constructed from materials that coarsen a surface of a land vehicle where the width of the substrate is not much more than a few inches and the height is not much more than a fraction of an inch.

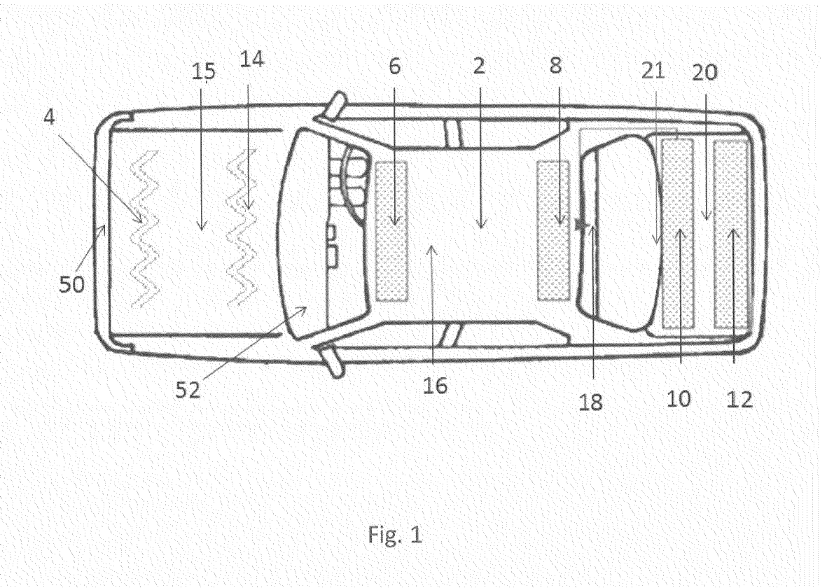

FIG. 1 illustrates a top view of a vehicle 2 that utilizes substrates 4-14 for reducing aerodynamic pressure drag, in accordance with the disclosed embodiments. Pressure drag occurs when turbulence behind leading edges of the vehicle 2 form lower pressure regions, i.e. lower with respect to undisturbed air and air in the forward portion of the vehicle 2. This pressure differential between the front of the vehicle 2 and rearward or aft areas opposes the forces moving the vehicle 2 forward through the air. These pressure differentials are referred to as pressure drag. Substrates 4-14 can be affixed to various surfaces on the vehicle 2 aft of leading edges on the vehicle 2 thereby reducing aerodynamic drag on the vehicle 2 by increasing the momentum of the boundary layer without requiring any additional energy from the vehicle 2.

For example, a substrate 4-14 can be placed on a leading edge of the roof surface just behind the windshield of the vehicle 2 where the free stream flow of air typically has laminar flow. It can be appreciated that the substrate 4-14 can be placed anywhere on the surface of the vehicle without departing from the scope of the invention. The substrate 4-14 can be made from a flexible magnetic material having a coarse texture on the surface over which air flows across the vehicle 2. A bottom layer of a packaging tape may be placed on the surface of a vehicle and an adhesive applied evenly over the packaging tape. A grit material can then be sprinkled on top of the adhesive after removing the masking tape and then dried. This forms one type of substrate whereby drag can be reduced on a vehicle.

Each substrate 4-14 can be a hard coarse-grained material such as silica or sand and may be configured from organic materials such as, for example, corn cob particles. It can be appreciated that any material that can be broken up into the desired particle sizes could be utilized to provide the texture on the surface of a substrate 4-14. In accordance with the present disclosure, the energy that creates the desired turbulence within the boundary layer comes from the free stream of air flow which is inherently present proximate to the surface of the vehicle 2. As the free flowing stream of air contacts substrates 4-14, it adds turbulence to the boundary layer that surrounds the vehicle 2.

As the boundary layer flow is turned from laminar flow to a turbulent flow, the momentum of the boundary layer flow is increased around the vehicle 2 without having to add or consume any additional vehicle energy. A substrate, such as that formed by gluing grit to tape, can be attached to the smooth external body surface of the vehicle to improve upon a vehicle's fuel economy.

The amount of disruption to the boundary layer can be increased or decreased using various substrate shapes, cross sectional profiles, thicknesses, and surface coarseness as determined by how much substrate 4-14 can “break up” smooth air flow and create turbulence in the boundary layer of flow.

In some embodiments each substrate 4-14 can be applied and aligned across the body of the car parallel and proximate to the front/leading edge of the vehicle's hood and/or the top of the windshield or roof (or perpendicular to the nominal airflow during travel). In some embodiments, substrates 4-14 can have a slight curvature or radius (or can be formed post facto to such a configuration) such that substrates 4-14 run or are placed centric or parallel to lines tangent to the curvature of a forward facing edge of the vehicle 2.

Each substrate 4-14 can have a nominal material thickness from twenty thousandths of an inch (0.02″) to one quarter inch thick (0.25″). The leading edge of each substrate 4-14 can be chamfered or tapered to reduce the aerodynamic force on the leading edge of each substrate 4-14, thereby preventing the prevailing airflow from overcoming the forces which hold the each substrate 4-14 to vehicle's surface.

In the airstream, the leading tapered edge of each substrate 4-14 can also produce a downward force on each substrate 4-14 thereby strengthening the bond between each substrate 4-14 and the surface of the vehicle 2. It can be appreciated that the force holding each substrate 4-14 onto the surface of the vehicle 2 should be greater than the force which a maximum velocity airstream (i.e. say 250 mph) can apply to each substrate 4-14 such that each substrate 4-14 does not move in relationship to the surface of the vehicle 2. It can also be appreciated that if a stream of air is allowed to get between a substrate 4-14 and the vehicle's surface, a substrate 4-14 will separate from the surface of the vehicle 2 and could be damaged or lost.

Some vehicle surfaces are made out of non-ferrous materials such as plastic, fiberglass, composite, aluminum, etc., and in these applications a substrate 4-14 can have clips 21 that fasten the leading edge of a substrate 4-14 to say the front edge of the hood. In some embodiments, the clips 21 can be configured as plastic “C” shaped clips 21 that can affix the substrate 4-14 to an edge or seam on the vehicle 2 such as a door edge, a trunk edge, a hood edge, etc. In some embodiments, clips 21 can be configured to attach to the leading edge or on the bottom side of each substrate 4-14 such that the clips 21 can be lodged in a seam and/or between two edges, surfaces or body parts such as between the front of the hood and its adjacent surface above the grill.

It is desirable that each substrate 4-14 can be attached to and removed from the desired location such that no damage occurs to the vehicle 2 and its protective coating. In some embodiments, a substrate 4-14 can be affixed to the vehicle 2 using a pressure sensitive double sided tape, possibly one that is washable and reusable and will not pull paint off of the vehicle 2.

When an airstream of sufficient velocity is present, each substrate 4-14 can reduce the effects of the pressure drag by creating a turbulent flow in the boundary layer around the vehicle 2. Each substrate 4-14 can add kinetic energy to the boundary layer and can move the separation point (where laminar flow transitions to turbulent flow) further aft, away from the front of the vehicle 2 or towards the back end of the vehicle 2. Moving the separation point further aft can reduce the effects of pressure drag on the vehicle 2 thereby making the vehicle more efficient.

It can be appreciated that materials of various coarseness such as sand or grit can be affixed or impregnated into substrates 4-14 to give a substrate 4-14 the desired texture for moving the separation point the desired distance or amount under the prevailing conditions. The coarseness of the surface of a substrate 4-14 can be defined by the size of the grit material utilized and the density of the grit material (particles per square inch) on a substrate 4-14. The particles can be placed on the substrate in varying density such that the particles occupy areas of varying particle density (i.e. particle per square inch). The ability of a substrate 4-14 to move the separation point back at specific air velocities can be defined not only by the placement of a substrate 4-14 on the vehicle but by the size of the particles on a substrate 4-14 and the density of particles (on the average) affixed to each square inch of a substrate 4-14.

Thus, in some embodiments, various sizes of particles in accordance with how sand paper is specified (100 fine grit, 50 medium grit, and 20 coarse grit) can be applied in various locations on a substrate 4-14 to maximize aerodynamic efficiency. The small particles may be affixed to each substrate 4-14 with glue or paint or some other form of adhesive. Further, the pattern of a substrate 4-14 can have varying geometric pattern or can be configured in many different shapes or with edges that are non-uniform, non-homogenous or not entirely parallel such as having a saw tooth or a wavy configuration perpendicular to the direction of the airflow. In other embodiments, a substrate 4-14 can be made from a material that is easy to cut with a knife or scissors such that an owner of a car can cut each substrate 4-14 to the desired size, configuration, geometry, design etc.

In some embodiments, the system can include sensors 15-20, computer 52, and a substrate deployment system 58. Sensors can detect low pressure areas, boundary layer separation, vortices, turbulence, and other aerodynamic phenomenon proximate to the surface of the vehicle 2. Computer 52 can receive environmental information from sensors 15-20 and can activate substrate deployment system 58.

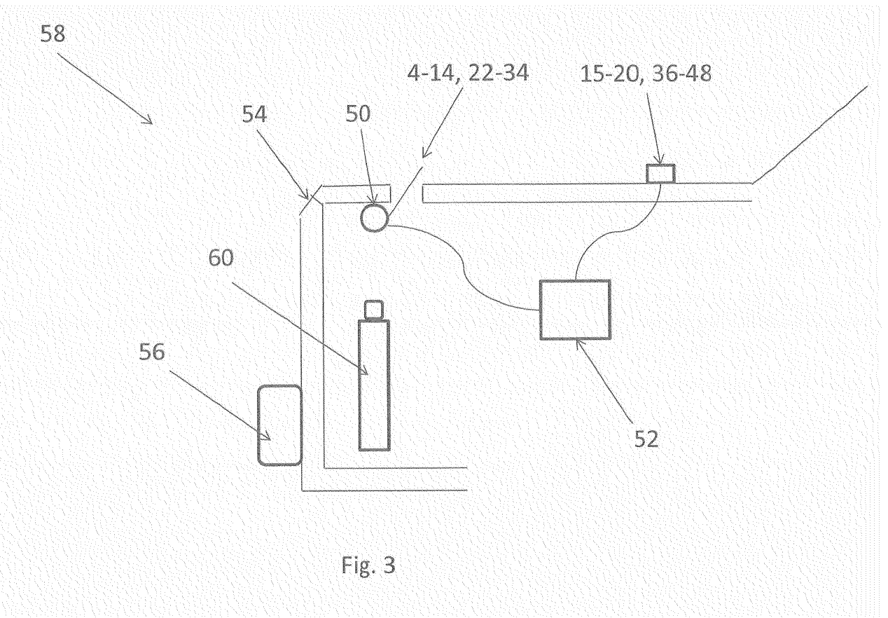

Substrate deployment system 58 can activate when certain environmental factors are detected. The substrates can be deployed into the boundary layer. The distance, height, degree, coarseness, and location of deployment of a substrate can be controlled by the computer 52 which receives feedback from the sensors 15-20. This will be described in greater detail in FIG. 3. In some embodiments, the substrates 4-14 can be of irregular shapes such as shown in substrate 4 and substrate 14.

Although a car is shown in the embodiment associated with FIG. 1, application of the teachings herein apply equally as well to other and vehicles such as buses, trucks, and/or trailers which could also benefit from the improvements to the art described herein. For example, since enclosed trailers, such as semitrailers have long uninterrupted surfaces, additional benefits would likely be derived by applying the teachings herein to such a trailer or truck body.

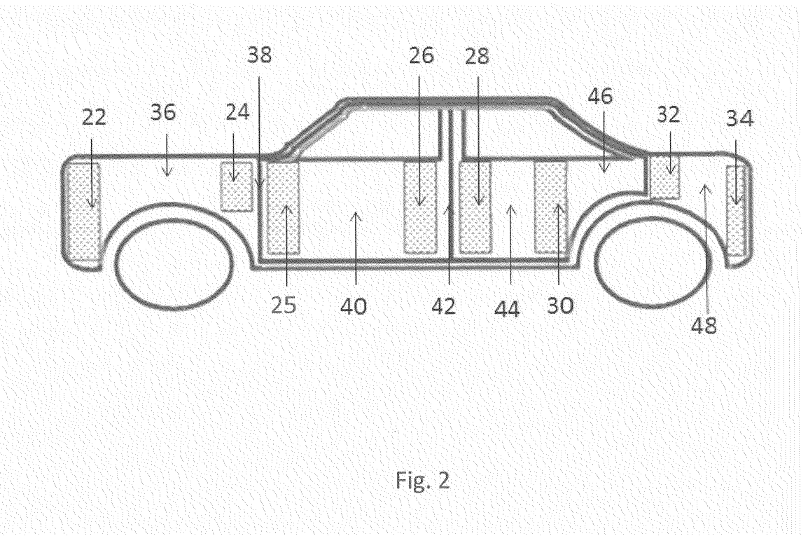

FIG. 1 illustrates one such application of a substrate 12 placed at the rear of a vehicle on the trunk or as in FIG. 2 a substrate 34 is placed on the rear fender. As the alternating shedding of vortices (referred to as Karman Vortex Street) causes a vehicle to sway back and forth, the application of substrates at the rear of a vehicle such as a trader or semitrailers may be reduced. This has the effect of further reducing drag on the vehicle.

FIG. 2 also illustrates how substrates 22-34 and sensors 36-48 could be configured on vertical surfaces of the vehicle 2. Pressure drag can occur on vertical oriented surfaces as well as the horizontal oriented surfaces. Similar to how the sensors can collect data on horizontally oriented as shown in FIG. 1, sensors can also process data on vertically oriented surfaces as shown in FIG. 2.

Reducing drag on a vehicle through the use of substrates is complex and requires the understanding of many related factors (surface and substrate dimensions, curvatures and texture of the vehicles surface, the shape, location, texture and orientation of the substrates, and correspondingly the speed of vehicle and where the separation points occur on the vehicle to name a few). Understanding aerodynamic efficiency requires the study of these interrelated parameters that are part of the vehicle's aerodynamic system.

There are many parameters and relationships between the parameters that affect the performance of aerodynamic systems, most of which can be identified and often optimized. But no matter how refined one's knowledge is regarding elements of an aerodynamic system, typically there are some elements of a system that remain unknown and variable, hence such systems are considered stochastic. It would be desirable to be able to adjust the substrate configuration on a vehicle based on varying conditions and to be able to optimize pressure drag conditions

FIG. 3 depicts a substrate deployment system 58. The system 58 can include an actuator 50, a computer 52, a substrate cover 54, substrates 4-14, 22-34 and sensors 15-20, 36-48. When vehicle 2 is moving, sensors 15-20, 36-48 can sense boundary layer and/or atmospheric conditions such as pressures proximate to one or more surfaces of the vehicle 2. When the sensors 15-20, 36-48 sense certain conditions, they can send the information to a computer 52 which can process information from the sensors and correspondingly send control signals to the actuator 50 which can change various parameters of the substrates to improve aerodynamic conditions.

In some embodiments the data received can be transmitted real time via a mobile communication system (i.e. cell phone, internet) where it can be processed and or stored for later analysis. As part of the deployment or adjustment, a substrate cover 54 can move allowing the substrate to deploy. As boundary layer conditions change based on change in conditions, (speed, air density, etc.) the sensors 15-20, 36-48 detect such changes and can send real time information to the computer 52 as feedback to changes made to the aerodynamic profile of the vehicle and the computer 52 can continue to adjust and control the position of the substrates 4-14, 22-34 to optimize pressure drag resistance on the vehicle 2. Thus, in some embodiments, a closed loop control system can be implemented.

In accordance with the disclosed embodiments, each substrate 22-34 can be manufactured with various surface textures, height, thickness, width, length coarseness, and/or roughness. The texture associated with the substrates 22-34 may include textures with particle sizes ranging from 80 imperfections per square inch to 5 imperfections per square inch.

A few parameters of a system that effect vehicle drag and correspondingly have an interdependent relationship include atmospheric conditions, vehicle speed, and a vehicle's surface conditions to include angle of attack, shape, coarseness, size, and position of any texture and/or protrusion that affects the flow of air at and/or proximate to the surface of the vehicle. Thus, different positions and dimensions of the disclosed substrate can produce significantly different aerodynamic effects. For example, placing a substrate 4-14 and 22-34 further back on a surface will affect the separation point of the airflow and consequently the pressure drag on the vehicle 2. However, placing a substrate 4-14 and 22-34 too far aft or towards the rear of a surface on the vehicle 2 can miss the preferred separation point and thus improper placement of a substrate 4-14 and 22-34 will have no useful effect on vehicle 2 efficiency.

In accordance with some embodiments, the thickness and placement of a substrate 4-14 and 22-34 can be adjusted, tailored, and/or tuned so that the substrate creates maximum efficiencies at a particular vehicle speed. It can be appreciated that the separation points on a particular vehicle with a particular configuration will not be static, as the separation points will change as the speed of the vehicle 2 changes, the wind speed changes, the angle of attack of the vehicle changes, etc. In some embodiments, a vehicle can be optimized for one of multiple profiles similar to profiles that are utilized for aircraft, for example, takeoff, ascent, cruise (optimized), descent, and landing. Thus, in accordance with some embodiments, vehicles equipped with tailored or strategically located substrates 4-14 and 22-34 will experience drag reducing phenomenon that is optimized for a particular type of driving profile, for example, city speeds, 20-55 mph or highway speeds, 55-80 mph, weight distribution, cross winds or something in between. In some embodiments, the substrate deployment system 58 can configure the location of the substrates 4-14 and 22-34 for various climate related conditions such as cold weather, high humidity, high cross winds, low humidity, etc.

In some embodiments, pressure sensors 15-20 and 36-48 can be placed on locations on the surface of a vehicle 2 to detect low pressure pockets at particular “sensitive locations” and substrates 4-14 and 22-34 can be activated or extended to protrude, to tailor the activity in the boundary layer to minimize the pressure drag on the vehicle 2 under various conditions. Thus, in some embodiments, a substrate deployment system 58 can be fully automated and installed such that the boundary layer profile or parameters can be sensed and change based on the current conditions occurring in the airflow that surrounds the vehicle.

At high speeds, if the disclosed substrate 4-14 and 22-34 is placed too far back from the leading edge, the separation point or the start of turbulent flow may occur ahead of the substrate 4-14 and 22-34 creating extra drag without providing any drag reduction benefit. However, at high vehicle speeds, if the substrate 4-14 and 22-34 is positioned too far forward, the effect on the separation point will be minimal or negligible at best.

It can be appreciated that establishing one configuration of substrates 4-14 and 22-34 on a vehicle 2 that takes into account each of the varying parameters and relationships is virtually impossible but configurations that make a significant impact can be the focus. Defining a varying set of conditions within which a particular substrate 4-14 and 22-34 configuration can provide measurable improvements preferred. Varying atmospheric conditions (temperature, humidity, air density, pressure, etc.) all have an effect or influence the efficiency of a vehicle's aerodynamic drag due to any changes in air flow conditions. In some embodiments, the driver of the vehicle 2 can view sensory data on a screen mounted within the vehicle, and via the interactive display activate substrates 4-14 and 22-34 in varying configurations and view the resulting data from the sensors to see if the pressure drag conditions can be improved by tailoring the substrate deployment.

Theory takes a back seat to experimental tests, which will demonstrate the optimal point for various substrates 4-14, and 22-34 placements or configurations under varying test conditions. While conclusions can be made for one type of vehicle 2, they will certainly vary from vehicle to vehicle depending on the circumstances. Our tests have shown that it is best to have substrates 4-14 and 22-34 of medium thickness placed near the leading edge of the vehicle's 2 surface in fair weather conditions (e.g. without rain).

Another method of drag reduction could be achieved by making permanent dimpled impressions on the surface of vehicle 2. Dimples manufactured into the material surface of a vehicle can be similar to dimples manufactured into golf balls.

Alternately, creating imperfections into a smooth sheet metal or fiberglass surface to add momentum to a boundary layer can be done by extending the surface material upward to impact the boundary layer of airflow over the sheet metal surface. The sheet metal would be deformed in a way that would form ridges, protrusions, or other features that simulate the effects of a coarse substrate while integrating the protrusion into the metal that forms a turbulator. Whether or not an embodiment uses dimples, recesses or protrusions, the spirit of the invention is to add momentum to the boundary layer.

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

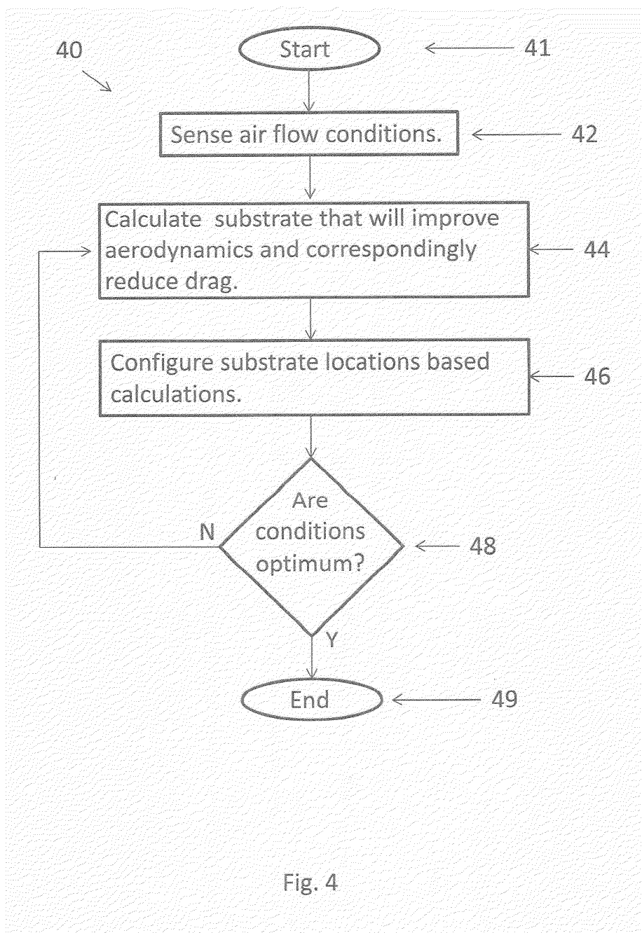

FIG. 4 is a flow chart 40 illustrating how substrates can be configured to reduce pressure drag on a vehicle. The process can begin at block 41 and proceed to block 42 where air flow conditions surrounding a vehicle can be sensed and determined. As illustrated by block 44, a computer can perform calculations in order to predict improved substrate configurations that will reduce drag on the vehicle. As illustrated by block 46, substrates can be configured according to the calculations as described in block 44.

As illustrated by block 48, it can be determined if aerodynamic conditions have been improved. If it is determined that substrate positioning has not been optimized, (possibly that changes decreased performance) one or more of the substrates can be configured/reconfigured as illustrated by block 44. When using sensory data, if it is determined that the positioning of each substrate has created an optimum performance based on the sensor data for that substrate, then the process can end as shown by block 49. Such a tailored approach employing substrates to create turbulence can greatly improve fuel economy.

Based on the foregoing, it can be appreciated that a drag reduction method and apparatus is disclosed for reducing aerodynamic pressure drag associated with a vehicle in motion by selective placement of a substrate with a specified texture to increase the momentum of boundary layer flow over a vehicle that in turn reduces aerodynamic drag.

The substrate associated with the grit material reduces the effects of the pressure drag by creating a turbulent boundary layer over the surface of the vehicle that moves a separation point from a laminar flow to a turbulent flow backwards along the vehicle. The reduction in pressure drag reduces the overall energy needed to move the vehicle through the air, which improves upon the fuel economy of the vehicle. This method of improving the fuel economy of the vehicle has been tested and proven successful. The application of a substrate with a texturized surface to any vehicle will significantly reduce the consumption of fuel, save money spent on fuel, and improve our nation's ability to become energy independent.

It can be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A method for reducing pressure drag on a land vehicle, comprising:
a land vehicle having a plurality of smooth uninterrupted surfaces including a hood, at least one door, a trunk lid and a roof, each uninterrupted surface having a leading edge and an trailing edge, wherein during movement of the land vehicle in the forward direction, the leading edge of the uninterrupted surface contacts resulting airflow prior to the airflow contacting the trailing edge; and
at least one substrate affixed proximate to a leading edge of at least one of the uninterrupted surfaces, the substrate comprising a textured surface protruding from the uninterrupted surface, the protrusions averaging from between thousandths (0.02) of an inch to one quarter (0.25) of an inch above the surface and the substrate covering from a quarter inch to three inches of the leading edge of the surface.

2. The method of claim 1, wherein said textured surface of said substrate providing obstructions to the smooth flow of air in a boundary layer, the obstructions extending above at least one of the uninterrupted surfaces an average height of 1/8 of an inch, the substrate being placed proximate to the leading edge of the at least one uninterrupted surface and being placed substantially parallel with and within the first four inches of the leading edge of the at least one uninterrupted surface.

3. The method of claim 1 wherein said substrate affixed to the vehicle utilizing one of pressure sensitive tape, clips, a magnetic force, paint, and glue.

4. The method of claim 1 wherein said substrate has a varying geometric pattern.

5. The method of claim 1, wherein the substrate is shaped such that its width varies forming non-homogenous edges.

6. The method of claim 1, wherein the texture is provided by affixing particles to the substrate, the particles being substantially uniform in size.

7. The method of claim 1 wherein the substrate comprises dimples or coarse protrusions permanently impressed into a surface of the vehicle.

8. An apparatus for reducing pressure drag on a and vehicle, said apparatus comprising:
a planer substrate having a first side and a second side;
particles affixed to the first side of the substrate to create a texture on said first side of said substrate; and
a securing mechanism affixed to the second side of the substrate to secure the substrate to a leading edge of and vehicle surfaces, the securing mechanism allowing the substrate to be one of permanent or removable from the and vehicle, wherein the substrate in the presence of air flow over said surface creates a turbulent boundary layer downstream from said leading edge thereby creating a separation point from a laminar flow to a turbulent flow downstream from said leading edge to thereby reduce the effects of pressure drag associated on said vehicle.

9. The apparatus of claim 8 wherein the securing mechanism allows for a location of the substrate to be moved in relation to the surface of the vehicle.

10. The apparatus of claim 8 further comprising:
an actuator coupled to the substrate;
a processor coupled to the actuator; and
at least one sensor coupled to the processor, wherein the sensor provides data to the processor and the processor controls the actuator to adjust the configuration of the substrate.

11. The apparatus of claim 8 wherein said texture is applied to the substrate while the substrate is affixed to said land vehicle.

12. The apparatus of claim 8 wherein said substrate is a semi rigid member.

13. The apparatus of claim 8 wherein said substrate has leading and trailing edges that have a varying geometric pattern.

14. The apparatus of claim 8 wherein said substrate has a trailing edge that has a saw tooth pattern.

15. The apparatus of claim 8 wherein said particles are secured to said strip of material using paint.

16. The apparatus of claim 8 wherein said particles are of varying granularity and occupy a space of varying particle density.

17. The apparatus of claim 8 wherein the particles form dimples in the substrate.

18. A drag control system comprising:
a substrate to affix to a and vehicle, the substrate having a texture;
at least one sensor to detect conditions related to airflow across at least one surface of the vehicle, said conditions effectible by how the substrate is configured in relation to the vehicle;
a processor coupled to the at least one sensor to receive data from the at least one sensor; and
an actuator coupled to the substrate to configure the substrate in relation to the vehicle wherein the configuration of the substrate's texture on the vehicle, in a presence of air flow, creates turbulence in a boundary layer downwind from the substrate, thereby reducing effects of pressure drag on said land vehicle.

19. The system of claim 18 wherein said substrate is deployed from a gap between two adjacent coplanar surfaces.

20. The system of claim 18 wherein said substrate is deployed differently based on the speed of the vehicle.
